(19) United States
(12) Patent Application Publication
(10) Pub. No.: US 2002/0015416 A1
(43) Pub. Date: Feb. 7, 2002

(54) Data transmission method for hybrid ARQ type II/III wide-band radio communication system

(76) Inventors: Yu-Ro Lee, Seoul (KR); Jae-Hong Park, Seoul (KR); Chong-Won Lee, Seoul (KR); Jeong-Hwa Ye, Seoul (KR)

Correspondence Address: BAKER & BOTTS, 30 ROCKEFELLER PLAZA, NEW YORK, NY, 10112

(21) Appl. No.: 09/832,253

(22) Filed: Apr. 10, 2001

(30) Foreign Application Priority Data
Apr. 10, 2000 (KR) 2000-18646
May 16, 2000 (KR) 2000-25966
Jun. 26, 2000 (KR) 2000-35455
Jun. 26, 2000 (KR) 2000-35456
Aug. 4, 2000 (KR) 2000-45159
Aug. 21, 2000 (KR) 2000-48435
Oct. 27, 2000 (KR) 2000-63614

(51) Int. Cl. H04J 3/22

(52) U.S. Cl. 370/466; 370/537

(57) ABSTRACT

A data processing method for the hybrid ARQ type II/III on a wide-band radio communication system includes the steps of: a) generating a data and side information on the radio link control (hereinafter, referred to as a RLC) layer and transmitting the generated data and the side information to MAC-D when a medium access control common (hereinafter, referred to as a MAC-C) converting a common channel part and a medium access control dedicated (hereinafter, referred to as a MAC-D) converting a common user part of the medium access control (hereinafter, referred to as a MAC) are separated from each other and exist on a different radio network; b) transmitting the data and the side information to a node B through a transport channel; and c) converting each of the data and the side information to a radio transmission form and transmitting it to a user equipment (UE) through a physical channel, after multiplexing.

### FIELD OF THE INVENTION

The present invention relates to a data processing method for hybrid automatic repeat for request (hereinafter, referred to as an ARQ) type II/III on a wide-band radio communication system; and, more particularly, to a method for data transmission by using two logical channels and one physical channel (preferred, a dedicated physical channel, DPCH) used in W-CDMA based on a next generation mobile communication network, such as an international mobile telecommunication (IMT) -2000 and a universal mobile telecommunications system (UMTS), and to a recording media having instructions for the method which can be read by a computer.

### DESCRIPTION OF THE PRIOR ART

Terms used in this specification will be described.

“A radio network controller-radio link control (RNC-RLC)” is a radio link control protocol level entity of a radio network controller (RNC).

“A radio network controller-medium access control dedicated entity (RNC-MAC-D)” is a medium access control protocol level dedicated entity of a radio network controller (RNC).

“A radio network controller-medium access control common/shared entity (RNC-MAC-C/SH)” is a medium access control protocol level terminal common/shared entity of a radio network controller (RNC).

“Node B-L1” is a physical channel layer entity of a node B. The node B represents a base transceiver station (BTS) in an asynchronous IMT-2000 system. In this specification, the node B is used as the same meaning as the base transceiver station (BTS).

“User equipment-L1 (UE-L1)” is a physical channel level entity of a user equipment (UE) (or a mobile station).

“User equipment-medium access control common/shared entity (UE-MAC-C/SH)” is a medium access control protocol level terminal common/shared entity of a user equipment (UE) (or a mobile station).

“User equipment-medium access control dedicated entity (UE-MAC-D)” is a medium access control protocol level terminal dedicated entity of a user equipment (UE) (or a mobile station).

“User equipment-radio link control (UE-RLC)” is a radio link control protocol level entity of a user equipment (UE) (or a mobile station).

“User equipment-radio resource control (UE-RRC)” is a radio resource control protocol level entity of a user equipment (UE) (or a mobile station).

“Iub” denotes an interface between the RNC and the Node B (BTS).

Iur” denotes an interface between the RNC and another RNC.

“Uu” denotes an interface between the Node B and the UE.

“Logical channel” is a logical channel used for transmitting and receiving data between the RLC protocol entity and MAC protocol entity.

“Transport channel” is a logical channel used for transmitting and receiving data between the MAC protocol entity and a physical layer.

“Physical channel” is a practical channel used for transmitting and data between a mobile station and a BTS.

When transporting the data from a radio network of a UMTS terrestrial radio access network (UTRAN) to the mobile station (MS), a Hybrid ARQ type II/III which has superior throughput than a Hybrid ARQ type I may be used.

FIG. 1 is a diagram showing a general wide-band radio communication network (W-CDMA). A UTRAN environment is used as an example in this drawing.

As described in FIG. 1, the UTRAN includes a user equipment (UE) 100, an asynchronous radio network 200 and a radio communication core network 300, such as a GSM-MAP core network.

A Hybrid ARQ type II/III is adapted between the UE 100 and the asynchronous radio network 200. When a received data has an error, the receiver requests the transmitter to re-transmit the received data.

FIG. 2 is a diagram showing a general UTRAN. In FIG. 2, the Iu is an interface between the radio communication core network 300 and the asynchronous radio network 200, and, the Iur means a logical interface between radio network controllers (RNC) of the asynchronous radio networks 200 and the Iub shows an interface between the RNC and the Node B. Meanwhile, the Uu shows a radio interface between the UTRAN and the UE 100.

In here, the Node B is a logical node, which is responsible for a radio transmission/receiving from one or more cell to the UE 100.

Generally in the UTRAN, if a received data has an error, the receiving part requests re-transmission of the data to the transmission part by using an automatic repeat request (ARQ) method. The ARQ method is divided to ARQ type I, II and III, and technical characteristics of each type are described as below.

The ARQ is an error control protocol, which automatically senses an error during transmission and then requests re-transmission of the error-containing block. That is, the ARQ is one of data transmission error control methods, and when an error is detected, automatically generates a re-transmission request signal to cause re-transmission of the signal.

The ARQ method is used in the UTRAN for a transmission packet data. The receiving part requests the transmission part to re-transmit an error-containing packet. However, when using the ARQ method, if the number of re-transmission requests is increased, then the throughput, which is amount of data transmitted in a predetermined period, is decreased. To solve the problem, the ARQ can be used along with a forward error correction coding (FEC) method, which is called as a hybrid ARQ.

The hybrid ARQ has three types I, II and III.

In case of type I, one coding rate is selected, for example, one coding rate selected from no coding, rate ½ and rate ⅓ of convolutional codings, according to channel environment or required quality of service (QoS), and the selected coding rate is continuously used. If there is a re-transmit request, the receiving part removes pre-received data and the transmission part retransmits the data with the pre-transmitted coding rate. In this case, the coding rate is not changed according to changeable channel environment, so, when compared with the type II and III the throughput may be decreased.

In case of type II ARQ, if the receiving part requests data re-transmission, then the data is stored onto a buffer at the receiver and the stored data is combined with the re-transmitted data. That is, at first, the data is transmitted with a high coding rate and in case of re-transmitting, the data is transmitted with a lower coding rate and it is combined with the pre-received stored data to increase efficiency compared to that of the type I. For example, a convolutional coding rate ¼, which is a mother code, may generates coding rates 8/9, ⅔ or ¼ by puncturing and it is called a rate compatible punctured convolutional (RCPC) code.

Meanwhile, a rate compatible punctured turbo (RCPT) code is obtained by puncturing a turbo code. At first, a data is transmitted with a coding rate of 8/9, and this version of the data is called as ver (0), an error is detected in the data by checking a cyclic redundancy check (CRC) and the data is stored to a buffer and re-transmission is requested. At this time, the re-transmission is performed with a coding rate ⅔ and the re-transmission version is being ver (1).

The receiving part combines the ver(0) data stored in the buffer and the ver(l) data, then the combined data is decoded and checked by the CRC. The above-referenced process is repeated until no error is detected, then, the last transmitted ver(n) is combined with a pre-transmitted ver(n−a)(0<a<n).

The type III ARQ is similar to the type II ARQ. It is different in that the re-transmitted ver(n) data is decoded before combined with the ver(n−a) data, and checked by the CRC then, if there is no error, the ver(n) data is transmitted to an upper layer. If an error is detected then, the re-transmitted ver(n) data is combined with ver(n−a) and checked by the CRC to determine if further data re-transmission is necessary

Accordingly, the hybrid ARQ type II/III is used for efficient data transmission in the UTRAN.

The hybrid ARQ type II/III combines a first data which is encoded with a high coding rate and a re-transmit data which is encoded with a low coding rate in the receiver to increase the throughput. Therefore, relational information between a sequence number and a re-transmitted version of a protocol data unit (PDU) is needed to be known in advance. The relation information should be transmitted with a low coding rate regardless of the retransmission coding rate, thereby ensuring its quality of communication.

The hybrid ARQ type II/III realization method in the UTRAN may differ depending on the application. In case of a downlink, data is transmitted through a downlink shared channel (DSCH) and in case of a time division duplex (TDD) uplink, the data is transmitted through an uplink shared channel, and includes the data part and information concerning the data, e.g., a data sequence number and a data version, etc. which are transmitted serially. However, the above-mentioned hybrid ARQ type II/III processing method increases a complexity of hardware.

The hybrid ARQ type II/III may have a different data coding rate for the transmission data part and the information part of the transmission data. That is, if an information part of a data may be converted and stored with A coding rate, and a data part may be converted and stored with B coding rate. In case of downlink, it is transmitted via a downlink shared channel (DSCH) and in case of uplink, transmitted via an uplink shared channel (USCH). Therefore, a coded data should be stored and hardware should be organized to use the data as needed which increases complexity.

### SUMMARY OF THE INVENTION

It is, therefore, an object of the present invention to provide a data delivery method for hybrid ARQ type II/III on a wide-band radio communication system for reducing a hardware complexity in the physical channel of a receiver by using two logical channels and one physical channel (preferably, a dedicated physical channel DPCH), and a recording media for storing instructions for the method capable of being read by a computer.

In accordance with an aspect of the present invention, there is provided a data processing method for a hybrid ARQ type II/III on a wide-band radio communication system, comprising the steps of: a) generating data and side information in the radio link control (hereinafter, referred to as a RLC) layer and transmitting the generated data and the side information to a medium access control dedicated (hereinafter, referred to as a MAC-D), when a medium access control common (hereinafter, referred to as a MAC-C), converting a common channel part, and the MAC-D, converting a dedicated user part of the medium access control (hereinafter, referred to as a MAC), are separated from each other and exist on different radio network's; b) transmitting the data and the side information to a node B through a transport channel; and c) converting each of the data and the side information to a radio transmission form and transmitting it to a user equipment (UE) through a physical channel, after multiplexing.

Also, the present invention further comprising the steps of: d) interpreting the received data and the side information by the UE and requesting a retransmission by noticing status of the received data to the radio network; and performing the steps a) to c) repeatedly by the asynchronous radio network, according to the re-transmission request of the UE.

In accordance with another aspect of the present invention, there is provided a data processing method for a hybrid ARQ type II/III on a wide-band radio communication system, comprising the steps of: a) generating data and side information in the radio link control (hereinafter, referred to as a RLC) layer and transmitting the generated data and the side information to a medium access control dedicated (hereinafter, referred to as a MAC-D), when a medium access control common (hereinafter, referred to as a MAC-C), converting a common channel part, and the MAC-D, converting a dedicated user part of the medium access control (hereinafter, referred to as a MAC), are separated from each other and exist on the same radio network; b) transmitting the data and the side information to a node B through a transport channel; and c) converting the data and the side information to a radio transmission form and transmitting it to a user equipment (UE) through a physical channel after multiplexing.

Also, the present invention further comprising the steps of: d) interpreting the received data and the side information by the UE and requesting a re-transmission by noticing status of the received data to the radio network; and performing the steps a) to c) repeatedly by the asynchronous radio network, according to the re-transmission request of the UE.

In accordance with still another aspect of the present invention, there is provided a computer readable data recording media having instructions for a data processing method for a hybrid ARQ type II/III on a wide-band radio communication system having a processor, comprising the functions of: a) generating a data and side information on the radio link control (hereinafter, referred to as a RLC) layer and transmitting the generated data and the side information to MAC-D when a medium access control common (hereinafter, referred to as a MAC-C), converting a common channel part, and a medium access control dedicated (hereinafter, referred to as a MAC-D), converting a dedicated user part of the medium access control (hereinafter, referred to as a MAC) are separated from each other and exist on different radio networks; b) transmitting the data and the side information to a node B through a transport channel; and c) converting each of the data and the side information to a radio transmission form and transmitting it to a user equipment (UE) through a physical channel, after multiplexing.

Also, the present invention further comprising the functions of: d) interpreting the received data and the side information by the UE and requesting are transmission by noticing status of the received data to the radio network; and e) performing the steps a) to c) repeatedly by the asynchronous radio network, according to the re-transmission request of the UE.

In accordance with still further another aspect of the present invention, there is provided a computer readable data recording media having instructions for a data processing method for a hybrid ARQ type II/III on a wide-band radio communication system having a processor, comprising the functions of: a) generating a data and side information on the radio link control (hereinafter, referred to as a RLC) layer and transmitting the generated data and the side information to MAC-D when a medium access control common (hereinafter, referred to as a MAC-C), converting a common channel part, and a medium access control dedicated (hereinafter, referred to as a MAC-D), converting a dedicated user part of the medium access control (hereinafter, referred to as a MAC) are separated from each other and exist on the same radio network; b) transmitting the data and the side information to a node B through a transport channel; and c) converting the data and the side information to a radio transmission form and transmitting it to a user equipment (UE) through a physical channel after multiplexing.

Also, the present invention further comprising the functions of: d) interpreting the received data and the side information by the UE and requesting a re-transmission by noticing status of the received data to the radio network; and e) performing the steps a) to c) repeatedly by the asynchronous radio network, according to the re-transmission request of the UE.

The present invention uses the hybrid ARQ type II/III method wherein a receiver requests a re-transmission when a system, which comprising an asynchronous user equipment (UE), an asynchronous radio network and a GSM-MAP core network, has an error.

The present invention provides a method, which generates a data and side information, respectively, in RLC and transmits the data and the side information to a node B through an internal radio network and processes the data and the side information in the node B then, transmits the data and the side information to the UE through one physical channel, such as DPCH. With this, conventional problems of the technology, especially increasing complexity of the physical channel of the transmission part may be solved.

### BRIEF DESCRIPTION OF THE DRAWINGS

Other objects and aspects of the invention will become apparent from the following description of the embodiments with reference to the accompanying drawings, in which:

FIG. 1 is a diagram showing a general W-CDMA network;

FIG. 2 is a diagram showing a general UTRAN;

FIG. 3A is a diagram showing a data transmission method when a transmission part in accordance with the present invention is a radio network, and MAC-D and MAC-C are operated in a different system;

FIG. 3B a diagram showing a data transmission method when a transmission part in accordance with the present invention is a radio network, and MAC-D and MAC-C are operated in a same system;

FIG. 4A is a flow chart showing a data transmission method when a transmission part in accordance with the present invention is a radio network, and MAC-D and MAC-C are operated in a different system;

FIG. 4B is a flow chart showing a data transmission method when a transmission part in accordance with the present invention is a radio network, and MAC-D and MAC-C are operated in a same system;

FIG. 5A is a flow chart showing a data transmission process in RLC of a radio network in accordance with the present invention;

FIG. 5B is a flow chart showing a data transmission process in MAC-D of a radio network in accordance with the present invention;

FIG. 5C is a flow chart showing a data transmission process in node B of a radio network in accordance with the present invention;

FIG. 6A is a flow chart showing a data transmission process in layer 1 of a user equipment in accordance with the present invention;

FIG. 6B is a flow chart showing a data transmission process in MAC-D of a user equipment in accordance with the present invention;

FIG. 6C is a flow chart showing a data transmission process in RLC of a user equipment in accordance with the present invention; and

FIG. 6D is a flow chart showing a data transmission process in RRC of a user equipment in accordance with the present invention.

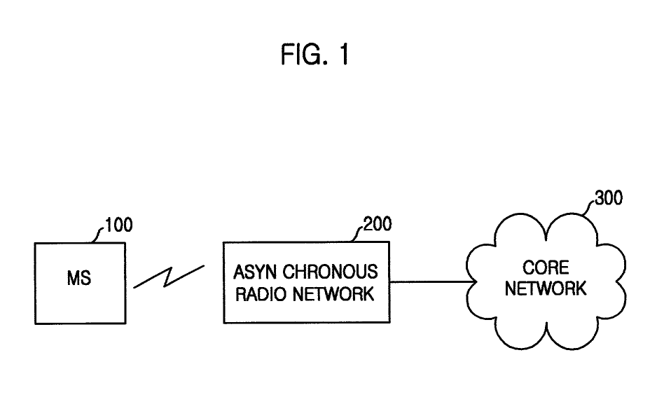

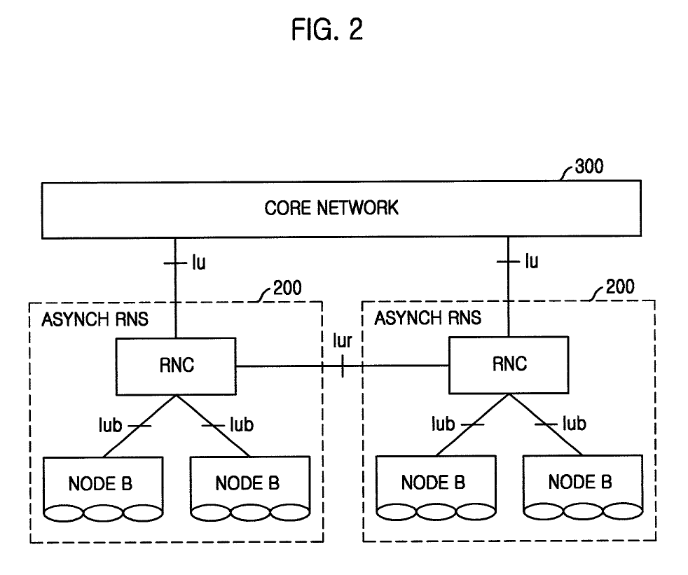

### DETAILED DESCRIPTION OF THE PREFERRED EMBODIMENTS

Hereinafter, a data processing method for hybrid ARQ type II/III on a wide-band radio communication system according to the present invention will be described in detail referring to the accompanying drawings.

The method of the present invention is that RLC generates a data and a side information, and the data and the side information are transmitted to a node B through an internal radio network, and the data and the side information are processed in the node B, then transmitted to a user equipment (UE) through one physical channel, such as DPCH.

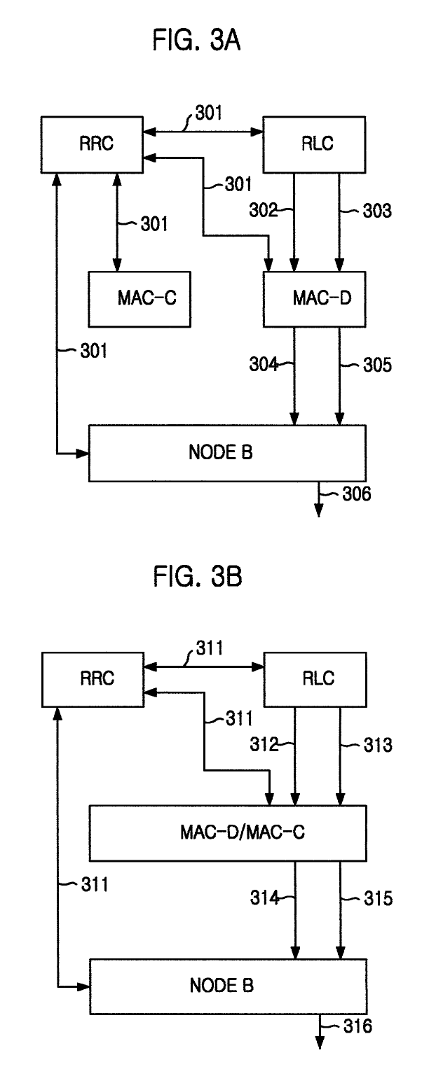

Referring to FIGS. 3A and 3B, two arrangements of an asynchronous radio network are shown. In FIG. 3A, MAC-C which manages common channel part, e.g., a broadcast channel, a random access channel (RACH), a pilot channel, etc., and MAC-D which manages a general user equipment, e.g., a dedicated channel, are performed by different entities. In FIG. 3B, MAC-C and MAC-D are performed by the same entity.

FIG. 3A is a diagram showing a data transmission method in a transmitter operating in accordance with the present invention, when MAC-D and MAC-C are performed in the different entities.

“301” is a RRC control signal.

“302” is a transmission function signal to transmit data received from an upper part to the MAC-D and the data is transmitted to the MAC-D through a logical channel such as a dedicated traffic channel (DTCH).

“303” is a transmission function signal to transmit side information (information concerning the signal “302”, such as a sequence number and a version number) to the MAC-D. The side information, e.g., a sequence number and a version number are transmitted to the MAC-D through a logical channel, such as the DTCH or a dedicated control channel (DCCH).

“304” is a transmission function signal to transmit data, which is received by the “302” signal, to the node B, and the data is transmitted to the node B through a transport channel, such as a dedicated channel (DCH).

“305” is a transmission function signal to transmit the side information, which is received by the “303” signal, to the node B, and the side information is transmitted to the node B through the transport channel, such as the DCH.

“306” is a transmission function signal to transmit the data and the side information, which are received by the “304” and the “305” signal, respectively, after converting them to a radio transmission form, and the data and the side information are transmitted to a receiver through the physical channel, such as the DPCH.

FIG. 3B is a diagram showing a data transmission method when a transmitter operating in accordance with the present invention wherein MAC-D and MAC-C are performed by the same entity. Explanation of each signal will be described.

“311” is a RRC control signal.

“312” is a transmission function signal to transmit a data received from an upper network to the MAC-D, and the data is transmitted to the MAC-D through the logical channel, such as the DTCH.

“313” is a transmission function signal to transmit side information (information concerning the “312” signal, e.g., a sequence number and a version number) to the MAC-D, and the side information is transmitted through a logical channel, such as the DTCH or the DCCH.

“314” is a transmission function signal to transmit the received data to the node B, and the data is transmitted to the node B through the transport channel, such as the DCH.

“315” is a transmission function signal to transmit the side information which is received by the “313” signal to the node B, and the side information is transmitted to the node B through the transport channel, such as the DCH.

“316” is a transmission function signal to transmit the data and the side information received from the “314” and the “315” signal, respectively, after converting them to a radio transmission form in the node B, and the data and the side information are transmitted to the receiver through the physical channel, such as the DPCH.

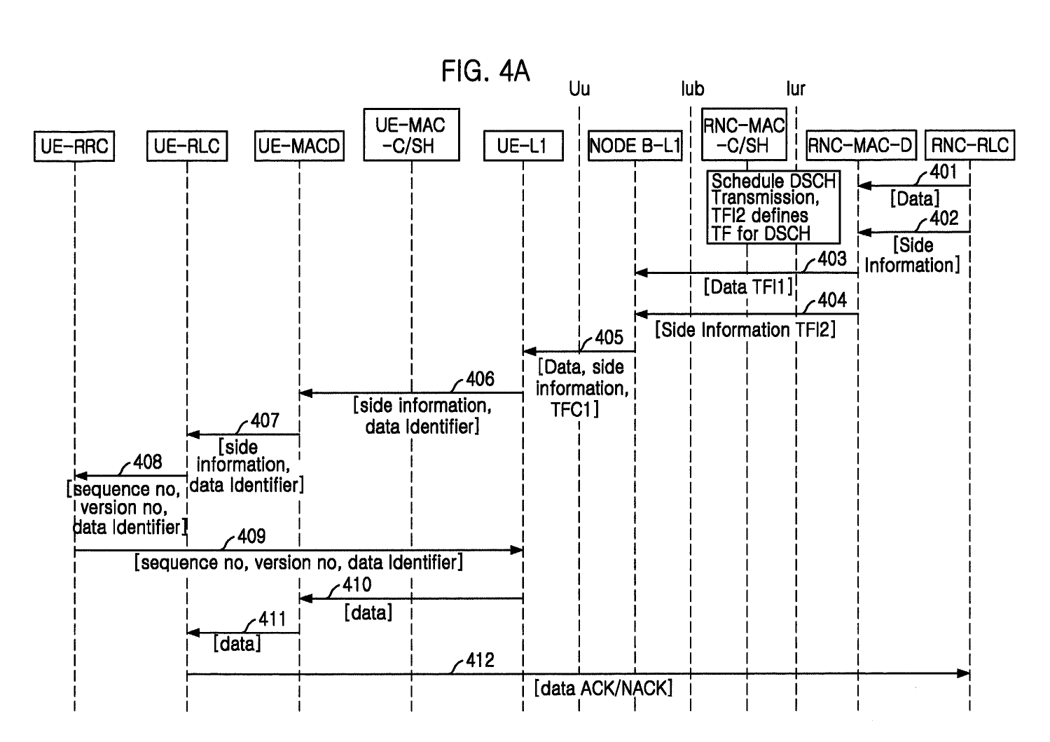

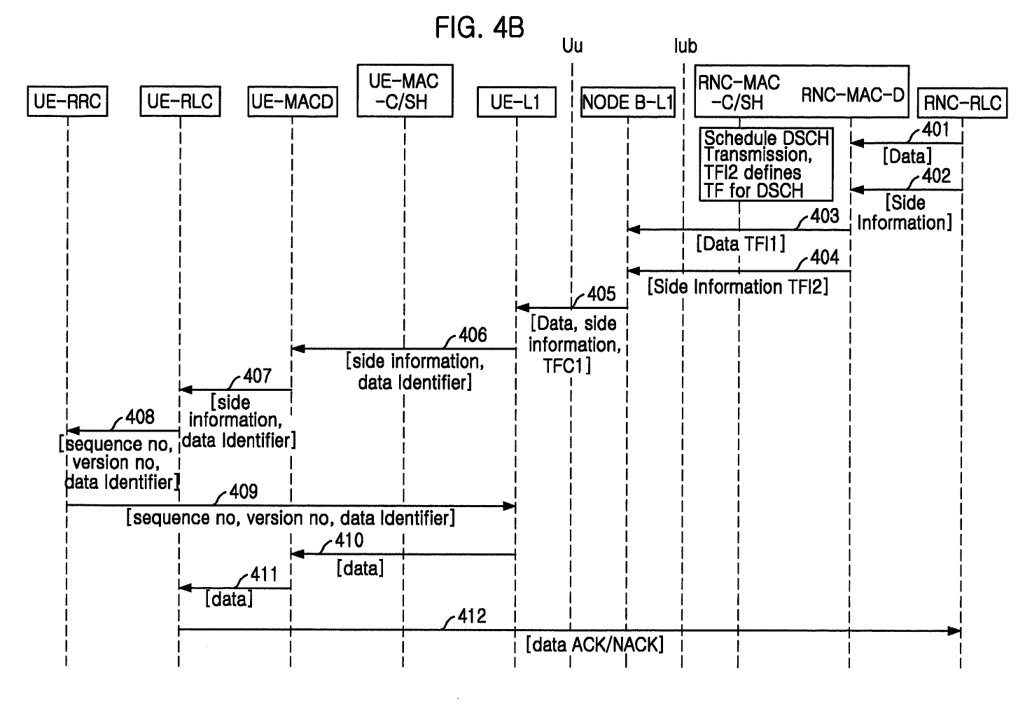

A data transmission process in a radio network when the MAC-D and the MAC-C are in the different entities (referring to FIG. 3A) is described in FIG. 4A. FIG. 4B illustrates a process when the MAC-D and the MAC-C are in the same entity (referring to FIG. 3B). Explanation of each signal and function is set forth in Table 1.

TABLE 1

| SIG- | | INCLUDED |
|---|---|---|
| NAL | FUNCTION | INFORMATION |
| 401 | Receiving data converted to MAC-D | Data, etc. |
| | transmission form from an upper network and | |
| | transmit it to the MAC-D through the logical | |
| | channel, such as the DTCH. | |
| 402 | Generating side information corresponding to a | Side information |
| | data of the “401” signal, and transmitting the | (sequence |
| | data to the MAC-D after converting it to the | number, version |
| | MAC-D transmission form, etc. through the | number, etc.) |
| | logical channel, such as the DTCH or the | |
| | DCCH. | |
| 403 | -Converting the “401” signal received from | -data, TFI, etc. |
| | RLC to a node B transmission form, and trans- | -when transmitted |
| | mitting the signal to the node B through the | with “404” |
| | transport channel, such as the DCH. | signal: data, TFI |
| | -it can be transmitted to the node B with the | (value for data), |
| | “404” signal. | side information, |
| | | TFI (value for |
| | | side information). |
| 404 | -Converting the “402” signal received from | Side information, |
| | RLC to a node B transmission form, and trans- | TFI, etc. |
| | mitting the signal to the node B through the | |
| | transport channel, such as the DCH. | |
| | -the signal can be transmitted to the node | |
| | B with the “403” signal. | |
| 405 | Converting the “401” and the “402” signals | Data, side inform- |
| | received from the MAC-D to a radio | ation, TFCI, etc. |
| | transmission form and transmitting the signals | |
| | to a user equipment through the physical | |
| | channel, such as the DPCH. | |
| 406 | Transmitting a part which includes the “404” | Side information, |
| | signal and a data identifier, among the received | data identifier, |
| | data, to the MAC-D through the transport | etc. |
| | channel, such as the DCH. | |
| 407 | Transmitting information received from the | Side information, |
| | “406” signal to RLC through the logical | data identifier, |
| | channel, such as the DTCH or DCCH. | etc. |
| 408 | Interpreting information received from the | Sequence |
| | “407” signal and transmitting the | number, version |
| | result to RRC through a specific | number, data |
| | primitive of the control SAP. | identifier, etc. |
| 409 | Transmitting information received from the | Sequence |
| | “408” signal to L1 through a specific | number, version |
| | primitive of a control SAP. | number, data |
| | | identifier, etc. |
| 410 | Convening the data part stored in the “405” | Data, etc. |
| | signal and transmitting it to the MAC-D | |
| | through the transport channel, such as | |
| | the DCH. | |
| 411 | Transmitting the data received from the “410” | Data, etc. |
| | signal to RLC through the logical channel, such | |
| | as the DTCH. | |
| 412 | Transmitting the data received from the “411” | ACK, NACK, |
| | data to the receiving part. | etc. |

In the [table 1], the RLC signal of the receiver determines whether re-transmission of the data is required, or not, and in case of re-transmitting, the RLC signal carries out from the “401” signal, repeatedly.

Referring to FIGS. 4A and 4B, a data transmission process when the D and the MAC-C are operated in a different entity or when the MAC-D and the MAC-C are operated in the same entity, in case of the transmitter in a radio network, is described, respectively.

As described in FIGS. 4A and 4B, in a data transmission method in accordance with the present invention, first, a radio network RLC generates data and RLC generates a side information part corresponding to the data, and each of the data and the information are transmitted to the node B of the radio network through the MAC-D, and the node B converts each of the data and the side information, and multiplexes them, and they are transmitted to the UE through the DPCH. The UE receives the side information to perform an ARQ operation.

The RLC converts the data received from the upper network and transmits the data to the MAC-D through the logical channel, such as the DTCH at step 401.

The RLC generates the side information, e.g., the sequence number and the version number of the data converted at step 401, and when data is transmitted to the MAC-D, the side information is transmitted to the MAC-D through the logical channel, such as the DTCH or the DCCH at step 402.

Next, the MAC-D converts the data received from the RLC to the node B transmission form and transmits the data to the node B through the transport channel, such as the DCH at step 403. At this time, when the MAC-D receives the data and the side information together, or receives them separately from the RLC, the MAC-D converts the data and the side information to the node B form according to the upper layer control signal and transmits the data and the side information to the node B after combining them to one signal.

Subsequently, the MAC-D converts the side information part received from the RLC to the node B form and transmits it to the node B through the transport channel, such as the DCH at step 404.

After that, the node B converts each of the data and the side information received from the MAC-D to a radio transmission form and multiplexing them for transmitting them via one physical channel, such as the DPCH, and transmits them to the UE at step 405.

The UE stores the data part of the received data to a layer 1 buffer and converts the side information part to a transmission form and transmits them with the data identifier to the MAC-D of the UE through the transport channel, such as the DCH at step 406.

The MAC-D of the UE converts the side information, e.g., side information, data identifier, etc., received from the layer 1 to the RLC transmission form and transmits it to the RLC through a logical channel, such as the DTCH, or the DCCH at step 407.

The RLC of the UE interprets the received data and extracts the sequence number and the version number, and transmits them to the RRC through a control SAP defined between the RLC and the RRC as a CRLC-HARQ-IND primitive at step 408.

Then RRC of the UE transmits a CHPY-HARQ-REQ primitive that has the sequence number, the version number and the data identifier, parameters of the CRLC-HARQ-IND primitive, as parameters to the layer 1 through a control SAP defined between the RRC and the layer 1 at step 409.

The layer 1 of the UE converts the stored data according to a received signal if a signal received from the RRC is corresponding to the stored data information, and converts the data to the MAC-D transmission form, then transmits it to the MAC-D through the transport channel, such as the DCH at step 410.

The MAC-D of the UE converts the received data to the RLC form and transmits the data to the RLC through the logical channel, such as the DTCH at step 411.

Finally, the RLC of the UE reports (ACK, NACK or report) the status of the received data to the radio network at step 412. Then, the RLC of the radio network determines re-transmission or not according to the reports of the received UE and in case of re-transmission, it carries out from step 401, repeatedly.

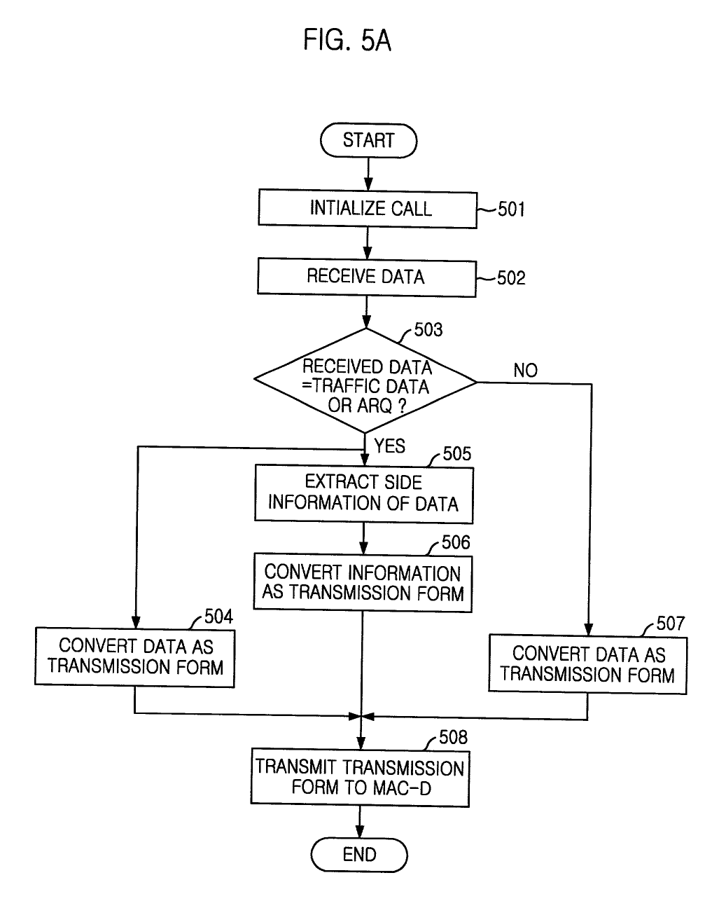

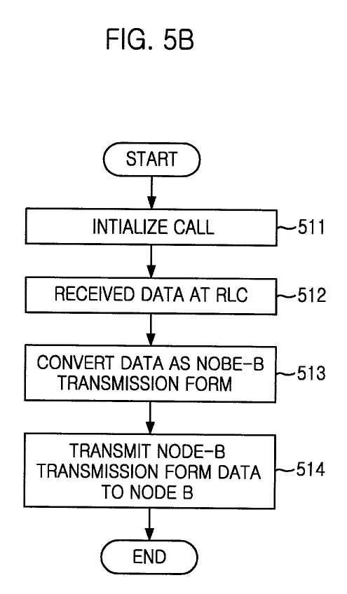

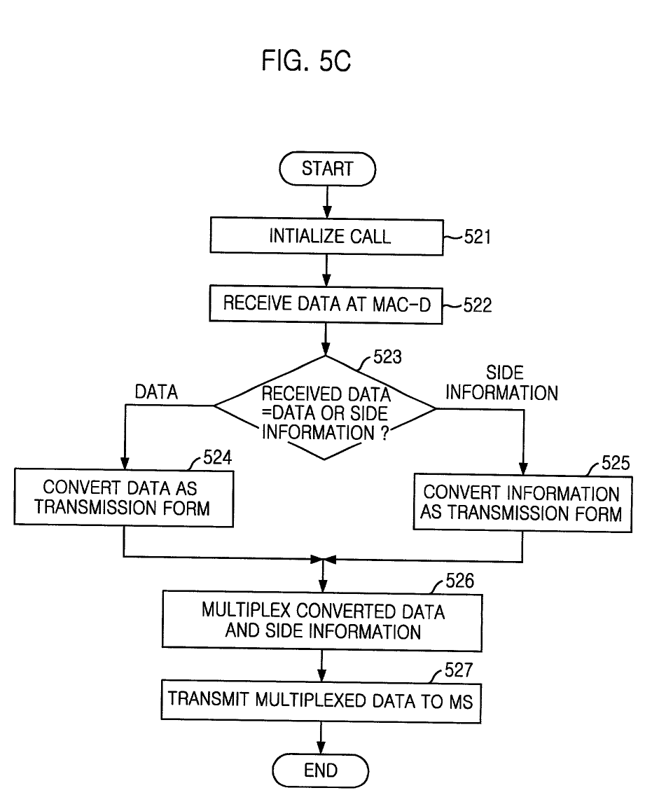

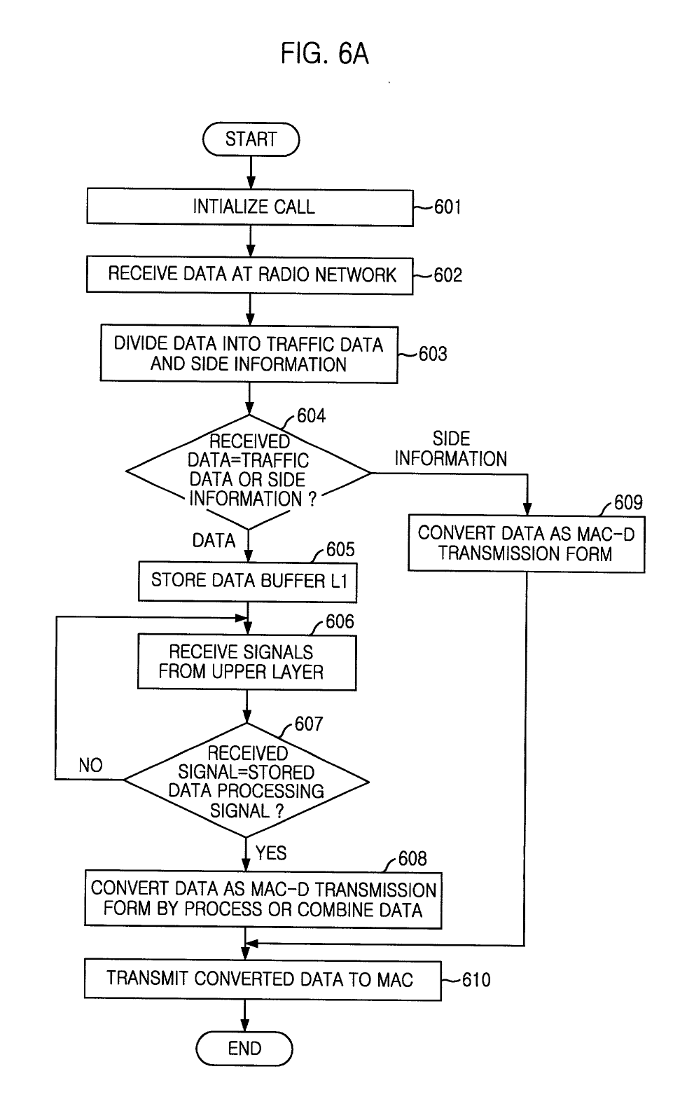

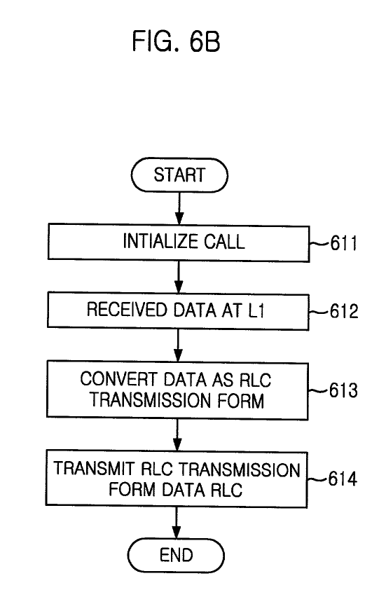

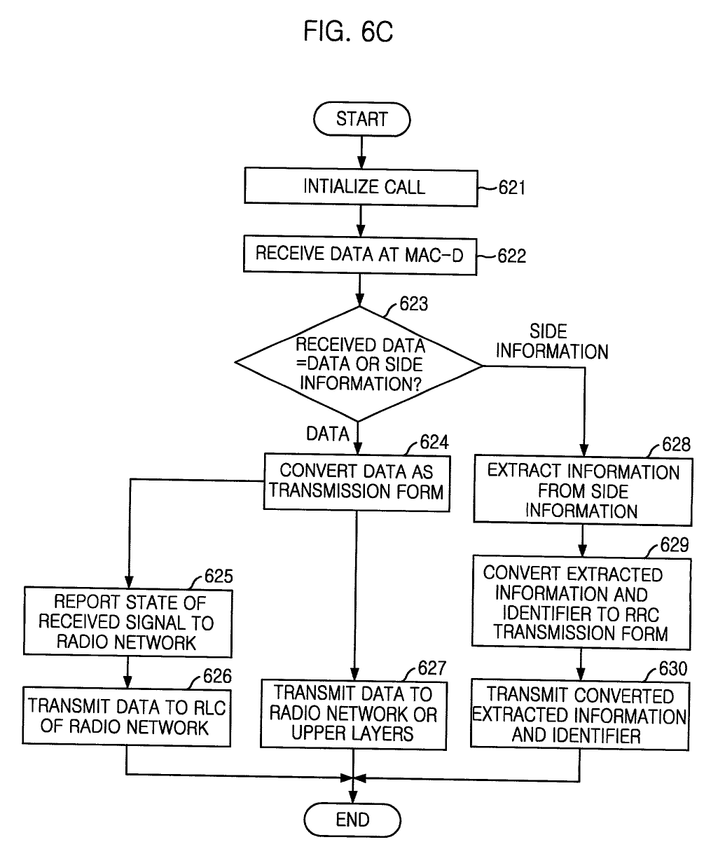

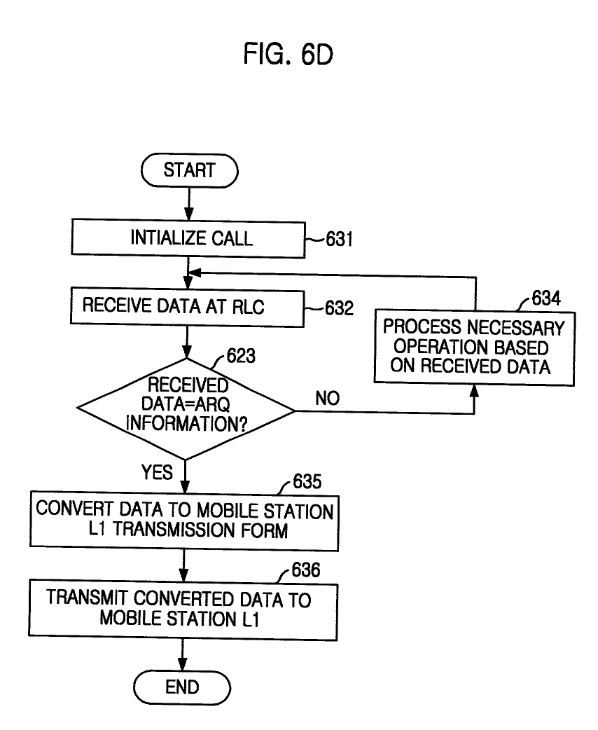

Descriptions of each part that converts and transmits the above-referenced signal are shown in FIGS. 5A to 5C and FIGS. 6A to 6D.

FIGS. 5A to 5C are for the each part operation of the asynchronous radio network and FIGS. 6A to 6D are for the each part of the UE.

FIG. 5A is a flow chart showing a data transmission process in RLC of a radio network in accordance with the present invention.

As described in FIG. 5A, the RLC of the asynchronous radio network for supporting the hybrid ARQ type II/III, first, initializing a call at step 501 and receiving a data from the upper network at step 502, then determining if the received data is a traffic data or a data that is made suitable for an automatic re-transmission request form at step 503.

After determining, in case of the received data is a traffic data or a data that is made suitable for an automatic re-transmission request form, then converts the received data to a transmission data form at step 504 and extracts the side information of the received data at step 505 and converts it to a transmission data form at step 506. At this time, the data that is converted to a transmission form is transmitted to the MAC-D through the logical channel, such as the DTCH and the side information is transmitted to the MAC-D through the logical channel, such as the DTCH at step 508.

That is, the RLC in the asynchronous radio network for supporting the hybrid ARQ type II/III determines the data received from the upper layer is traffic data or data that is made suitable for an automatic re-transmission request form, and in case of the data is a traffic data or a data that is made suitable for an automatic re-transmission request form, then converts the data to the MAC-D transmission form and the side information, e.g., the sequence number and the version number are also converted to the MAC-D transmission form, and transmits the data, converted to the transmission form, to the MAC-D through the logical channel, such as the DTCH and transmits the side information part of the data, converted to the transmission form to the MAC-D in parallel with the data through a logical channel, such as the DTCH and the DCCH.

After determining, if the received data is not a traffic data or a data that is made suitable for an automatic re-transmission request form, then, converts the received data to the transmission data form at step 507 and transmits each of the data to the MAC-D at step 508.

FIG. 5B is a flow chart showing a data transmission process in MAC-D of a radio network in accordance with the present invention.

As described in FIG. 5B, the MAC-D of the asynchronous radio network for supporting the hybrid ARQ type II/III, first, initializing a call at step 511 and receiving data from the RLC at step 512, and converting the received data to the node B transmission form at step 513, then, transmits the data to the node B through the transport channel, such as the DCH at step 514.

In case of the upper layer control signal and the data part and the data information part are received together, the MAC-D converts the data part and the data information part to the node B transmission form and transmits them to the node B with one signal.

FIG. 5C is a flow chart showing a data transmission process in node B of a radio network in accordance with the present invention.

As described in FIG. 5C, the node B of the asynchronous radio network for supporting the hybrid ARQ type II/III, first, initializing a call at step 521 and receiving a data from the MAC-D at step 522, then determining if the data which is received with the upper layer information and the information followed with the received data is a traffic data or a data that is made suitable for an automatic re-transmission request form at step 523.

After determining, if the received data is a traffic data or a data that is made suitable for an automatic re-transmission request form, then, converting the received data according to the received TFI and the layer 1 control information at step 524, and if the received data is the side information, then, converting the received data according to the received TFI and the layer 1 control information at step 525, and multiplexing the data and the side information, then transmits the multiplexing result to the UE through the physical channel, such as the DPCH at step 527.

FIG. 6A is a flow chart showing a data transmission process in layer 1 of a user equipment in accordance with the present invention.

As described in FIG. 6A, the layer 1 of the asynchronous UE for supporting the hybrid ARQ type II/III, first, initializing a call at step 601 and receiving a data from the radio network through the physical channel, such as the DPCH at step 602 and separating the data part and the side information part from the received data at step 603, then determines whether the separated data is the data or the side information at step 604.

After determining, in case of the separated data is the side information, then converts the data to the MAC-D transmission form at step 609 and transmits the converted data to the MAC-D through the transport channel, such as the DCH at step 610.

After determining, if the separated data is the data, then storing the data to the buffer of the layer 1 at step 605 and receiving the upper layer signal at step 606, then, analyzing the received signal which is corresponding to the stored data at step 607.

After analyzing, the received signal is a signal about the stored data and performing a layer 1 operation, e.g., decoding or combining with the pre-data, and converting the data to the MAC-D transmission form at step 608, then transmitting the converted data to the MAC-D through the transport channel, such as the DCH at step 610.

FIG. 6B is a flow chart showing a data transmission process in MAC-D of a user equipment (UE) in accordance with the present invention.

As described in FIG. 6B, the MAC-D of the asynchronous UE for supporting the hybrid ARQ type II/III, first, initializing a call at step 611 and receiving a data from the layer 1 at step 612 and converting the data to the RLC transmission form at step 613. In a transmission the converted data to the RLC, if the converted data is corresponding to the side information, then transmits it to the RLC through the logical channel, such as the DTCH and the DCCH, and if the converted data is a user data, then transmits the data to the RLC through the logical channel, such as the DTCH at step 614.

FIG. 6C is a flow chart showing a data transmission process in RLC of a user equipment (UE) in accordance with the present invention.

As described in FIG. 6C, the RLC of the asynchronous UE for supporting the hybrid ARQ type II/III, first, initializing a call at step 621 and receiving a data from the MAC-D at step 622 and determining the received data is the data or the side information at step 623.

After determining, if the received data is the side information, then extracting essential information, e.g., the sequence number and the version number from the side information at step 628 and converting the extracted information and the data identifier to RRC converting form at step 629, then transmitting the converted data, such as the sequence number, the version number and the data identifier to the RRC through specific primitive (CRLC-HARQ-IND) of the control SAP at step 630.

After determining, if the received data is the data, then converting the data to a network converting form at step 624 and transmits it to the network (or the upper layer) at step 627.

Then, make a report signal that the status of the received signal to the asynchronous radio network at step 625, and transmits it to the RLC of the asynchronous radio network at step 626.

FIG. 6D is a flow chart showing a data transmission process in RRC of a user equipment (UE) in accordance with the present invention.

As described in FIG. 6D, in the RRC of the asynchronous UE for supporting the hybrid ARQ type II/III, first, initializing a call at step 631 and receiving a data from the RLC at step 632 and determining whether the received data is ARQ related information or not at step 633.

After determining, if the received data is the ARQ related information, then converting the received data to the layer 1 transmission form at step 635 and transmitting the converted data, such as the sequence number, the version number and the data identifier to the layer 1 through a specific primitive (CPHY-HARQ-REQ) of the control SAP at step 634.

After determining, if the received data is not the ARQ related information, then converting the corresponding process according to the received data, and transiting to the step 632 which receives data from the RLC.

As described above, the present invention assumes an asynchronous radio communication system as a preferred embodiment, however, a synchronous radio communication system using the hybrid ARQ type II/III also generates each of a data and a side information in RLC and transmits each of the data and the side information to a node B through internal radio network, and operates the data and the side information in the node B, then, transmits it to a user equipment (UE) through one physical channel, such as the DPCH.

The present invention divides the side information part that has information, such as a header of a data, and a user data part to regulate each of coding rates so that an error-generating rate of the side information part is decreased. Also it can check whether an error is generated in the side information part or not by dividing the user data part and a data is processed after checking the side information, so that the combining is stably performed.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

I(we) claim:

1. A data processing method for the hybrid ARQ type II/III on a wide-band radio communication system, comprising the steps of:
a) generating data and side information in a radio link control (hereinafter, referred to as a RLC) layer and transmitting the generated data and the side information to a median access control dedicated (hereinafter, referred to as a MAC-D), when a medium access control common (hereinafter, referred to as a MAC-C), converting a common channel part, and MAC-D, converting a dedicated user part of the medium access control (hereinafter, referred to as a MAC), are separated from each other and exist on different radio networks;
b) transmitting the data and the side information to a node B through a transport channel; and
c) converting each of the data and the side information to a radio transmission form and transmitting the data to a user equipment (UE) through a physical channel after multiplexing.

2. A data processing method for the hybrid ARQ type II/III on a wide-band radio communication system, comprising the steps of:
a) generating data and side information in a radio link control (hereinafter, referred to as a RLC) layer and transmitting the generated data and the side information to a medium access control dedicated (hereinafter, referred to as a MAC-D), when a medium access control common (hereinafter, referred to as a MAC-C), converting a common channel part, and the MAC-D, converting a dedicated user part of the medium access control (hereinafter, referred to as a MAC), are separated from each other and exist on the same radio network;
b) transmitting the data and the side information to a node B through a transport channel; and
c) converting the data and the side information to a radio transmission form and transmitting it to a user equipment (UE) through a physical channel after multiplexing.

3. The data processing method as recited in claim 1, further comprising the steps of:
d) interpreting the received data and the side information by UE and requesting a re-transmission by noticing status of the received data to the radio network; and
e) performing the steps a) to c) repeatedly by the asynchronous radio network, according to the re-transmission request of the UE.

4. The data processing method as recited in claim 3, wherein the radio network is an asynchronous radio network.

5. The data processing method as recited in claim 4, wherein the d) step includes the steps of:
d1) storing a data part of the received data in a layer 1 buffer and converting the side information part to the MAC-D transmission form, then transmitting it with the data identifier to the MAC-D of the UE through a transport channel;
d2) converting the side information received from the layer 1 to the RLC transmission form and transmitting it to the RLC of the UE through the logical channel;
d3) interpreting the received data and transmitting it to the RRC of the UE;
d4) converting the data received from the RLC of the UE to the layer 1 form and transmitting to the layer 1;
d5) if the received signal received from the RRC of the UE corresponds to the stored data information, then, converting the stored data according to the received signal and transmitting it to the MAC-D of the UE through the transport channel;
d6) converting the received data to the RLC form and transmitting it to the RLC of the UE through the logical channel; and
d7) reporting the status of the received data to the radio network.

6. The data processing method as recited in claim 5, wherein in the step e), determines re-transmission or not according to the received report and in case of re-transmission, carries out the steps a) to c) repeatedly.

7. The data processing method as recited in claim 4, wherein the logical channel is a dedicated traffic channel (DTCH) for transmitting the data of the RLC layer to the MAC-D.

8. The data processing method as recited in claim 7, wherein the logical channel is selected from the DTCH and a dedicated control channel (DCCH) logical channel for transmitting the side information to the MAC-D in parallel when the data in the RLC layer is transmitted to the MAC-D through the DTCH logical channel.

9. The data processing method as recited in claim 8, wherein the transport channel is a dedicated channel for transmitting the data and the side information to the node B.

10. The data processing method as recited in claim 9, wherein the physical channel is a dedicated physical channel (DPCH) for transmitting the data and the side information to the UE.

11. The data processing method as recited in claim 10, wherein the step a) includes the steps of:
a1) converting the data received from the upper layer and transmitting to the MAC-D through the DTCH logical channel; and
a2) making side information of converted data in the a1) step and transmitting the data to the MAC-D through the DTCH or the DCCH logical channel in parallel when the data part is transmitted to the MAC-D.

12. The data processing method as recited in claim 11, wherein the step b) includes the steps of:
b1) converting the data part received from the RLC layer to a node B transmission form and transmitting the data to the node B through the DCH transport channel; and
b2) converting the side information part to the node B transmission form and transmitting it to the node B through the DCH transport channel.

13. The data processing method as recited in claim 11, wherein in the step b), when the MAC-D receives the data part and the side information part from the RLC layer, a data part and a side information part are converted to the node B transmission form according to an upper layer control signal and transmitted to the node B by combining into one signal when the MAC-D receives the data part and the side information part from the RLC layer.

14. The data processing method as recited in claim 12, wherein in the step c), the node B converts the data and the side information received from the MAC-D to a radio transmission form and multiplexes them for transmission to the DPCH physical channel, then, transmits the data and the side information to the UE.

15. The data processing method as recited in claim 10, wherein the data transmission process in the RLC layer of the radio network includes the steps of:
g) determining if the received data is a traffic data or a data that is made suitable for an automatic re-transmission request form;
h) after determining, in case of the received data is a traffic data or a data that is made suitable for an automatic re-transmission request form, then, converts the received data to a transmission data form and extracts the side information of the received data and converts the side information data to a transmission data form;
i) transmitting the converted data to the MAC-D through the DTCH logical channel and the converted side information to the MDC-D through the DCCH logical channel; and
j) after the determining the g) step, in case of the received data is not a traffic data or a data that is made suitable for an automatic re-transmission request form, then converting the received data to the transmission data form and transmitting them to the MAC-D.

16. The data processing method as recited in claim 15, further comprising the step of: k) after performing the step h), transmitting the converted data and the side information to the MAC-D through the DTCH logical channel.

17. The data processing method as recited in claim 10, wherein the data transmission process of the MAC-D of the radio network includes the steps of:
g) converting a data received from the RLC layer to the node B transmitting form and transmitting the converted data to the node B through the DCH transport channel; and
h) in case of the control signal of the upper layer or a data part and a data information part is received together, then, converting the data part and the data information part to the node B transmission form and combining the data part and the data information part and transmitting it to the node B.

18. The data processing method as recited in claim 10, wherein the data transmission process of the node B of the radio network includes the steps of:
g) determining whether the received data from the MAC-D is a data or side information;
h) converting the data and the side information according the determining result of the step g), then, multiplexing the result to transmit the data and the side information through a DPCH physical channel; and
i) transmitting the multiplexed result to the UE through the DPCH physical channel.

19. The data processing method as recited in claim 5, wherein the data transmission process of the layer 1 of the radio network includes the steps of.
m) dividing the received data from the radio network to a data part and side information part;
n) storing the divided data part to layer 1 until a signal of a upper layer is generated;
o) in case of a signal information is acquired, then converting the stored data according to the upper layer signal;
p) converting the converted data to the MAC-D transmission form and transmitting the data to the MAC-D through the DCH transport channel; and
q) converting the divided side information to the MAC-D transmission form and transmitting it to the MAC-D through the DCH transport channel with the data identifier.

20. The data processing method as recited in claim 5, wherein the data transmission process of the MAC-D of the radio network includes the steps of:
m) converting a data received from the layer 1 of the UE to RLC transmission form;
n) after performing the step m), in case of the data converted to the RLC transmission form is corresponded to side information, then, transmitting the data to the RLC of the UE through the DTCH or the DCCH logical channel; and
o) after performing the step m), in case of the data converted to the RLC transmission form is corresponded to a user data, then, transmitting the data to the RLC of the UE through the DTCH logical channel.

21. The data processing method as recited in claim 5, wherein the data transmission process of the RLC of the UE includes the steps of:
m) determining whether the data received from the UE MAC-D is a data part or a side information part;
n) after determining, in case of the received data is the data part, then, converting the received data part to a network (or the upper layer) transmission form;
o) transmitting the converted data part to the network (or the upper layer);
p) forming status of the received data part to the RLC transmission form of the radio network then transmitting it to the RLC of the radio network through the MAC-D and the layer 1 of the UE;
q) after determining, in case of the received data is the side information, interpreting the received side information part and extracting an essential part;
r) converting the extracted essential part of the side information and the data identifier received from the MAC-D of the UE to RRC transmission form; and
s) transmitting the converted data to RRC of the UE.

22. The data processing method as recited in claim 5, wherein the data transmission process of the RRC of the UE includes the steps of:
m) determining whether the data received from the RLC of the UE is a part corresponding to the ARQ; and
n) after determining, converting the ARQ corresponding part to a layer 1 transmission form, and transmitting the data to the layer 1 of the UE.

23. A data recording media having recorded thereon machine readable instructions for a data processing method for the hybrid ARQ type II/III on a wide-band radio communication system having a processor, comprising the functions of:
a) generating a data and side information on the radio link control (hereinafter, referred to as a RLC) layer and transmitting the generated data and the side information to MAC-D when a medium access control common (hereinafter, referred to as a MAC-C) converting a common channel part and a medium access control dedicated (hereinafter, referred to as a MAC-D) converting a common user part of the medium access control (hereinafter, referred to as a MAC) are separated from each other and exist on a different radio network;
b) transmitting the data and the side information to a node B through a transport channel; and
c) converting each of the data and the side information to a radio transmission form and transmitting it to a user equipment (UE) through a physical channel, after multiplexing.

24. A data recording media having recorded thereon machine readable instructions for a data processing method for the hybrid ARQ type II/III on a wide-band radio communication system having a processor, comprising the functions of:
a) generating a data and side information on the radio link control (hereinafter, referred to as a RLC) layer and transmitting the generated data and the side information to MAC-D when a medium access control common (hereinafter, referred to as a MAC-C) converting a common channel part and a medium access control dedicated (hereinafter, referred to as a MAC-D) converting a common user part of the medium access control (hereinafter, referred to as a MAC) are separated from each other and exist on the same radio network;
b) transmitting the data and the side information to a node B through a transport channel; and
c) converting the data and the side information to a radio transmission form and transmitting the data to a user equipment (UE) through a physical channel, after multiplexing.

25. The data recording media as recited in claim 23, further includes the functions of:
d) interpreting the received data and the side information by the UE and requesting a re-transmission by noticing status of the received data to the radio network; and
e) performing the steps a) to c) repeatedly by the asynchronous radio network, according to the re-transmission request of the UE.
